(19) United States
(12) Patent Application Publication
(10) Pub. No.: US 2011/0306450 A1
(43) Pub. Date: Dec. 15, 2011

(54) Ratchet-based drive belt adjusting device

(76) Inventor: Calvin Chou, Taichung Hsien (TW)

(21) Appl. No.: 12/802,555

(22) Filed: Jun. 9, 2010

(51) Int. Cl. F16H 7/14

(52) U.S. Cl. 474/114

(57) ABSTRACT

A ratchet-based drive belt adjusting device includes a rotatory seat having a connecting end to be pivotally connected to a machine tool; a ratchet hole extending along the rotational direction, wherein the ratchet hole has one peripheral edge formed with a plurality of unidirectional ratchets; a through hole for the rotatory shaft to pierce therethrough, wherein the rotatory shaft after passing thorough the through hole is mounted with a pulley around which a drive belt is mounted; a lever having an escape tooth positioned inside the ratchet hole, wherein the lever and the escape tooth are rotatably and coaxially connected to the machine tool so that the escape tooth is allowed to movably engage with any of the ratchets; and a driving wheel set axially connected to the machine tool for being mounted with the drive belt.

### BACKGROUND OF THE INVENTION

1. Technical Field

The present invention relates to devices for adjusting tension of drive belts, and more particularly to a drive belt adjusting device, which implements a rotatory seat to adjust a distance between an power input shaft and a driving shaft, and uses unidirectional ratchets for braking and positioning so as to rapidly adjust tension of a drive belt on the two shafts. The present invention is applicable to machine tools operated by drive belts and driving shafts.

2. Description of Related Art

Drive belts are extensively used in many industrial machine tools, such as various woodworking machines, for transmitting deriving force and rotational movement between shafts. Transmission achieved by friction between belts and pulleys is advantageously smoother and quitter as compared with that achieved by metal chains or gears because of the elasticity and tenacity of the material of which the belts are made.

For supporting different rotation rates, a driving wheel set is typically composed of several driving wheels of different diameters for a drive belt to be mounted therearound. When adjustment of rotation rate is desired, the drive belt released from one driving wheel is mounted to another driving wheel corresponding to the desired rotation rate and then tensioned. In industrial practice, adjustments of rotation rates has to be performed frequently for meeting processing demands of different workpieces, and consequently drive belts are likely to get loosen after frequently relaxed and tensioned. Once a loosen drive belt receives external force, it tends to vibrate in operation and such vibration can significantly aggravate wear between the shafts and the drive belt, leading to shortened service life of the components. Therefore, the drive belt has to be regularly tensioned properly so as to ensure stable transmission.

A conventional drive belt adjusting device, as shown in FIG. 1, is to be assembled to a machine tool and primarily comprises a rotatory seat 1, a handle 2, a power device 3 and a driving wheel 4. The rotatory seat 1 has a connecting end connected to the machine tool so that the rotatory seat 1 is allowed to rotate against the connecting end. The power device 3 fixed to the rotatory seat 1 has an output shaft pierces through the rotatory seat 1 to allow a pulley 5 rotatably mounted therearound. A drive belt 6 is mounted around the pulley 5 and the driving wheel 4. The rotatory seat 1 is formed with a slot 7. The handle 2 is connected to the tool machine with a belt 8 positioned in the slot 7. A pushing member 9 is set between the handle 2 and the rotatory seat 1 for normally pushing the handle 2 to abut against the rotatory seat 1. To tension the drive belt 7, the belt 8 is unscrewed to release the pushing member 9 from the rotatory seat 1, and then the rotatory seat 1 is pressed downward or pulled upward to vary the distance between the pulley 5 and the shaft of the driving wheel 4. Meantime, the handle 2 is operated to screw the belt 8, so that the pushing member 9 abuts against the rotatory seat 1 again and the adjustment is accomplished.

However, the adjustment as described above requires an operator to use his/her both hands to operate the rotatory seat 1 and the handle 2 at the same time. For tensioning the drive belt 7, the operator who continuously exerts a downward force to the rotatory seat 1 is apt to have his/her arm tired and fail to hold the rotatory seat 1 tight when screwing the handle 2. In this case, the rotatory seat 1 is not positioned bottommost and enable to tension the drive belt 7 properly. Hence, the conventional drive belt adjusting device is not perfect for the purposes of quick, convenient and reliable adjustment of the tension of the drive belt 7.

### SUMMARY OF THE INVENTION

In view of the shortcomings of the prior art device, the present invention herein provides a ratchet-based drive belt adjusting device, which comprises a rotatory seat having a connecting end to be pivotally connected to a machine tool so that the rotatory seat is allowed to rotate with respect to the machine tool in a rotational direction against the connecting end; a ratchet hole extending along the rotational direction, wherein the ratchet hole has one peripheral edge formed with a plurality of unidirectional ratchets; and a through hole for the rotatory shaft to pierce therethrough, wherein the rotatory shaft after passing thorough the through hole is mounted with a pulley around which a drive belt is mounted; a lever having an escape tooth positioned inside the ratchet hole, wherein the lever and the escape tooth are rotatably and coaxially connected to the machine tool so that the escape tooth is allowed to movably engage with any of the ratchets; and a driving wheel set axially connected to the machine tool for being mounted with the drive belt.

One objective of the present invention is to provide the aforementioned ratchet-based drive belt adjusting device, wherein the rotatory seat adjusts the distance from the rotatory shaft to the driving wheel set so as to tension or relax the drive belt and engagement between the escape tooth and the ratchets limits the rotatory seat to rotate unidirectionally.

Another objective of the present invention is to provide the aforementioned ratchet-based drive belt adjusting device, which allows an operator to operate the rotatory seat and the lever with single hand, so as to achieve rapid, convenient and reliable operation.

Still another objective of the present invention is to provide the aforementioned ratchet-based drive belt adjusting device, wherein the engagement between the escape tooth and the ratchets allows an operator to operate the rotatory seat with less force, thereby achieving effort-saving operation.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a schematic drawing of a conventional drive belt adjusting device;

FIG. 2 is a perspective view of a ratchet-based drive belt adjusting device of the present invention applied to a woodworking lathe;

FIG. 3 is an exploded view of the ratchet-based drive belt adjusting device of the present invention applied to the woodworking lathe;

FIGS. 4 and 5 illustrate operation of the ratchet-based drive belt adjusting device to tension a drive belt; and

FIGS. 6 and 7 illustrate operation of the ratchet-based drive belt adjusting device to relax the drive belt

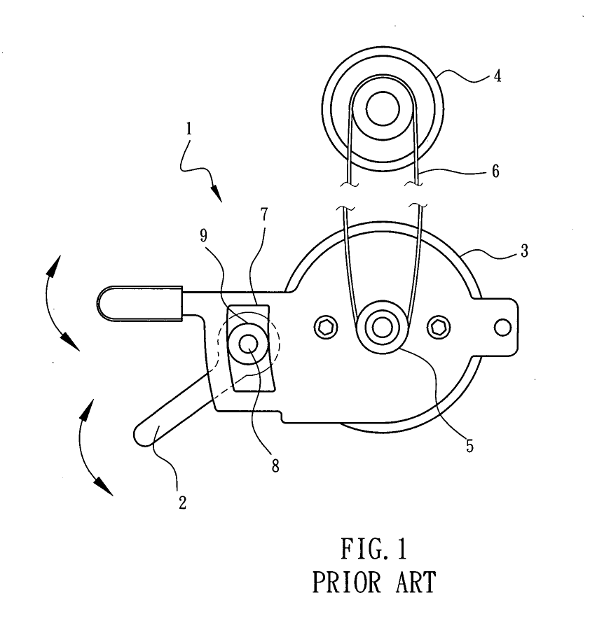

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made to exact scale.

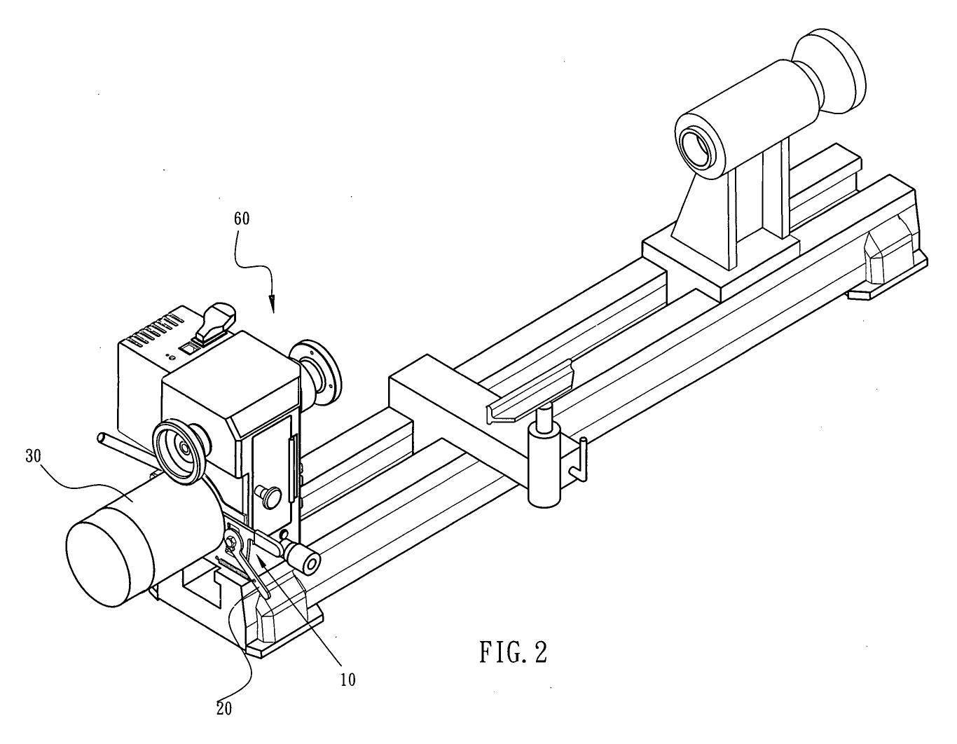

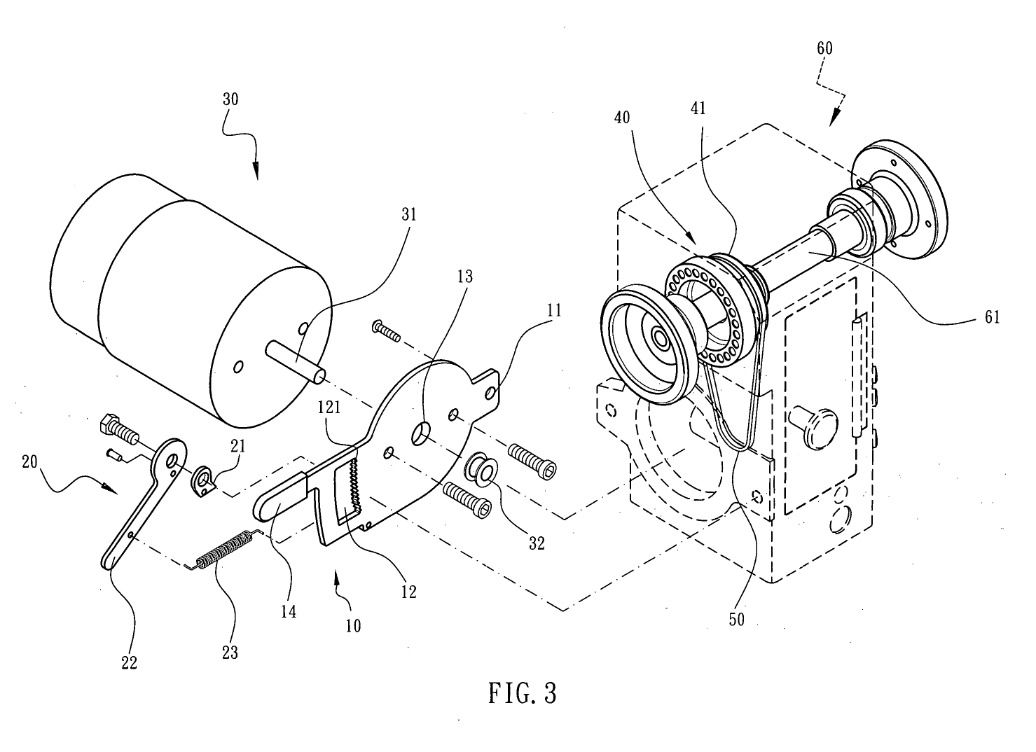

Referring to FIG. 2 and FIG. 3, the present invention is a ratchet-based drive belt adjusting device, which primarily comprises a rotatory seat 10, a lever 20, a power device 30 and a driving wheel set 40. The device of the present invention is to be assembled to a machine tool 60. The machine tool 60 is the one implementing the drive belt 50 to drive the driving wheel set 40, such as a woodworking lathe, or a grinding wheel machine. According to the embodiment shown in the drawings, the present invention is applied to the depicted woodworking lathe to adjust tension of the drive belt 50.

The rotatory seat 10 has a connecting end 11 pivotally connected to the machine tool 60 so that the rotatory seat 10 is allowed to rotate against the connecting end 11. A ratchet hole 12 whose one peripheral edge is formed with a plurality of unidirectional ratchets 121 is provided on the rotatory seat 10 and extending along rotational direction thereof. The rotatory seat 10 further has a through hole 13. A handle 14 is provided on the rotatory seat 10 opposite to the connecting end 11 for an operator to operate and thereby manually rotate the rotatory seat 10.

The lever 20 laterally has an escape tooth 21 and is rotatably connected to the machine tool 60 together and coaxially with the escape tooth 21. The escape tooth 21 is positioned inside the ratchet hole 12. The lever 20 has an end opposite to the end connected to the machine tool 60 extended with a handle 22 for controlling the lever 20 to move so as to make the escape tooth 21 movably engage with or depart from any of the ratchets 121. A spring 23 is arranged between the lever 20 and the rotatory seat 10, for ensuring that the escape tooth 21 normally engages with any of the ratchets 121.

The power device 30 is a motor fixed to the rotatory seat 10. A rotatory shaft 31 juts out of one end of the power device 30 as an output shaft of the power device 30. The rotatory shaft 31 pierces through the through hole 13 for a pulley 32 to be mounted therearound.

The driving wheel set 40 is connected to a main shaft 61 of the machine tool 60, and is composed of a plurality of driving wheels 41 with different diameters. The driving wheels 41 are arranged in order of their diameters.

The drive belt 50 is mounted around the pulley 32 and one of the driving wheels 41, so that power from the power device 30 is allowed to drive the driving wheel set 40 through the drive belt 50.

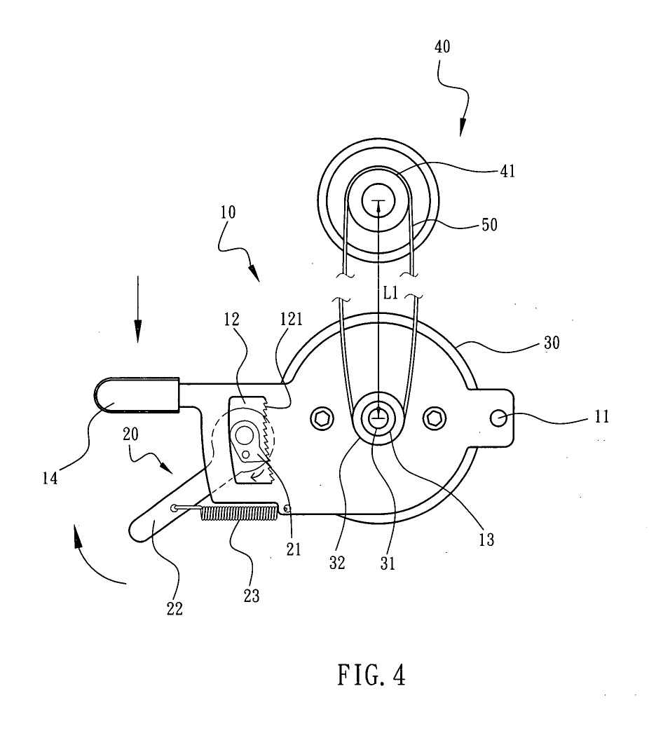

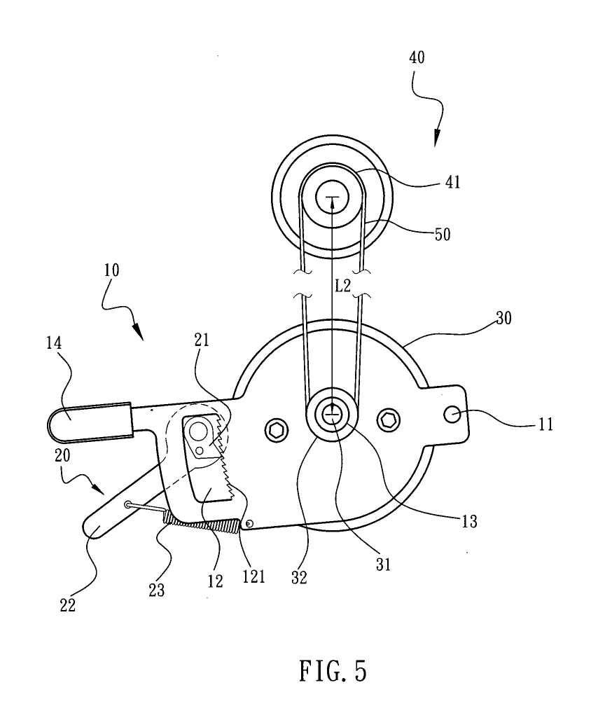

Referring to FIG. 4, when the drive belt 50 is loosened, the escape tooth 21 engages with the ratchet 121, and the distance from the rotatory shaft 31 to the main shaft 61 is L₁. According to FIG. 5, to tension the drive belt 50, the handle 14 is pushed downward so the rotatory seat 10 rotates in one direction against the connecting end 11. In virtue of the engagement between the escape tooth 21 and any of the ratchets 121, the rotatory seat 10 is positioned. Thereby, the rotatory seat 10 is posed as downward leaned, and the lever 20 rotates frontward along with the rotatory seat 10, thereby pressing the escape tooth 21 to firmly engage with the ratchet 121. Consequently, the power device 30 also moves downward along with the rotatory seat 10. As a result, the distance between the rotatory shaft 31 and the main shaft 61 is increased to L₂ from L₁, making the drive belt 50 tensioned.

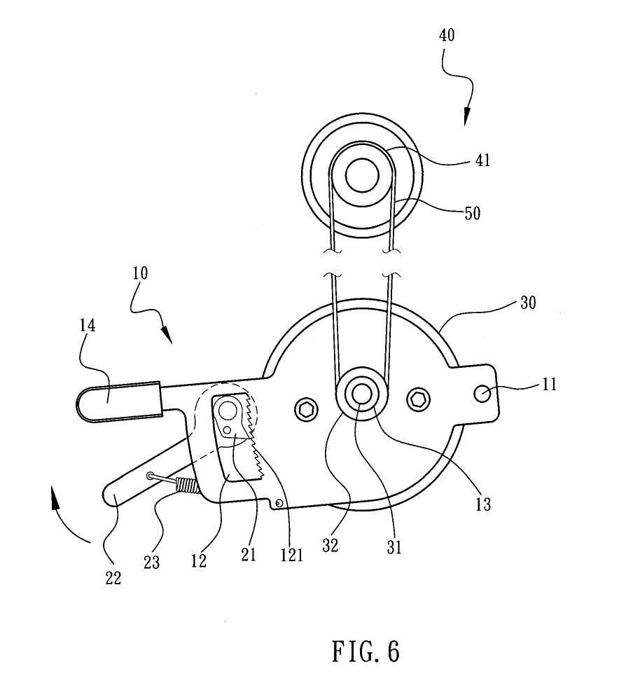

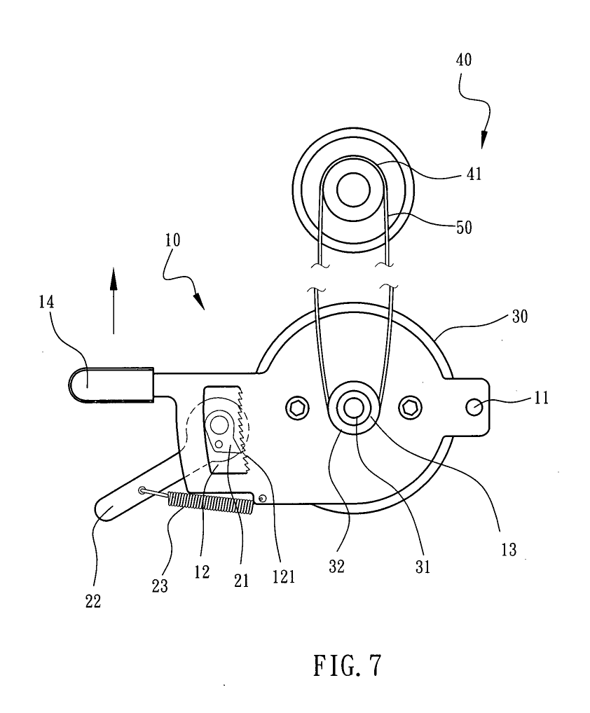

As shown in FIG. 6, to relax the drive belt 50, the handle 22 is pulled upward so as to separate the escape tooth 21 from the ratchet 121, and the rotatory seat 10 is ready to rotate. Referring to FIG. 7, when the handle 22 is pulled upward, the handle 14 is pulled upward, so the rotatory seat 10 rotates upward to in turn make the power device 30 move upward along with the rotatory seat 10. At this time, the distance between the rotatory shaft 31 and the main shaft 61 is shortened, causing the drive belt 50 loosened.

After the drive belt 50 is such loosened, it can be remounted around the driving wheel 41 corresponding to the desired rotation rate of the main shaft 61, and re-tensioned. Thereby, the present invention allows the drive belt 50 to be easily and rapidly replaced or combined with different diving wheels 41.

The present invention has been described with reference to the preferred embodiment and it is understood that the embodiment are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A ratchet-based drive belt adjusting device, comprising:
a rotatory seat having:
a connecting end to be pivotally connected to a machine tool so that the rotatory seat is allowed to rotate with respect to the machine tool in a rotational direction against the connecting end;
a ratchet hole extending along the rotational direction, wherein the ratchet hole has one peripheral edge formed with a plurality of unidirectional ratchets; and
a through hole for a rotatory shaft to pierce therethrough, wherein the rotatory shaft after passing thorough the through hole is mounted with a pulley around which a drive belt is mounted;
a lever having an escape tooth positioned inside the ratchet hole, wherein the lever and the escape tooth are rotatably and coaxially connected to the machine tool so that the escape tooth is allowed to movably engage with any of the ratchets; and
a driving wheel set axially connected to the machine tool for being mounted with the drive belt,
whereby, operation of the rotatory seat adjusts a distance from the rotatory shaft to the driving wheel set, so as to tension or relax the drive belt, and engagement between the escape tooth and the ratchets limits the rotatory seat to rotate unidirectionally.

2. The ratchet-based drive belt adjusting device of claim 1, wherein a spring is provided between the lever and the rotatory seat, for ensuring that the escape tooth normally engages with any of the ratchets.

3. The ratchet-based drive belt adjusting device of claim 1, wherein a handle is formed at one end of the rotatory seat opposite to the connecting seat for being operated to rotate the rotatory seat.

4. The ratchet-based drive belt adjusting device of claim 1, wherein the lever is extended with a handle opposite to the machine tool for being operated to rotate the lever, and in turn make the escape tooth engage with or depart from any of the ratchets.

5. The ratchet-based drive belt adjusting device of claim 1, wherein the driving wheel set comprises a plurality of driving wheels with different diameters arranged in order of the diameters thereof.

6. The ratchet-based drive belt adjusting device of claim 1, wherein the rotatory shaft is a power output shaft of a power device.

7. The ratchet-based drive belt adjusting device of claim 6, wherein the power device is a motor.

8. The ratchet-based drive belt adjusting device of claim 6, wherein the power device is fixed to the rotatory seat, so that the drive belt transmits power from the power device to the driving wheel set.
